(19) United States
(12) Patent Application Publication
(10) Pub. No.: US 2012/0179545 A1
(43) Pub. Date: Jul. 12, 2012

(54) System and Method for Computer-Implemented Advertising Based on Search Query

(76) Inventor: James R. Everingham, Santa Cruz, CA (US)

(21) Appl. No.: 13/352,188

(22) Filed: Jan. 17, 2012

Related U.S. Application Data
(63) Continuation of application No. 13/005,226, filed on Jan. 12, 2011.

(51) Int. Cl. G06Q 30/02

(52) U.S. Cl. 705/14.54

(57) ABSTRACT

Provided herein are systems and method for monetizing a search interface. In one embodiment, for example, there is provided a method comprising (a) receiving a search query from a user; (b) identifying a plurality of documents responsive to the search query; (c) identifying a creative relevant to the search query; and (d) providing the user with the plurality of documents and at least one relevant creative. The creative may be selected based on a subject tag and/or product tag present in the search query. In one embodiment, the systems and methods described herein are used in computer-implemented advertising.

### CROSS-REFERENCE TO RELATED APPLICATIONS

This application is a Continuation of U.S. patent application Ser. No. 13/005,226, filed Jan. 12, 2011, the entire disclosure of which is herein incorporated by reference in its entirety.

### SUMMARY

Provided herein are systems and method for monetizing a search interface. In one embodiment, for example, there is provided a method comprising (a) receiving a search query from a user; (b) identifying a plurality of documents responsive to the search query; (c) identifying a creative relevant to the search query; and (d) providing the user with the plurality of documents and at least one relevant creative. The creative may be selected based on a subject tag and/or product tag present in the search query. In one embodiment, the systems and methods described herein are used in computer-implemented advertising.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level diagram illustrating a system for practicing the methods presented herein.

FIG. 2 is a flow-chart illustrating one embodiment presented herein.

FIG. 3 is a schematic drawing of a computer system used to implement the methods presented herein.

### DEFINITIONS

Prior to describing the present invention in detail, it is useful to provide definitions for key terms and concepts used herein.

Ad server: One or more computers, or equivalent systems, which maintains a database of creatives, delivers creative(s), and/or tracks advertisement(s), campaign(s), and/or campaign metric(s) independent of the platform where the advertisement is being displayed.

“Advertisement” or “ad”: One or more images, with or without associated text, to promote or display a product or service. Terms “advertisement” and “ad,” in the singular or plural, are used interchangeably.

Cataloging: Act of organizing, sorting, indexing, and/or classifying creatives.

Content of the creative: The general subject matter contained within the creative. For example, if the creative is advertising a black purse, the content of the creative is the purse.

Creative: A document, hyperlink, or thumbnail with advertisement, image, or any other content or material related to a product or service.

Crowdsourcing: The process of delegating a task to one or more individuals, with or without compensation.

Document: Broadly interpreted to include any machine-readable and machine-storable work product (e.g., an email, a computer file, a combination of computer files, one or more computer files with embedded links to other files, web pages, digital image, etc.).

Product tag: Metadata used to identify, index, and/or describe the content of a creative.

Specificity of the creative: The specific subject matter contained within the creative. For example, if the creative is advertising a black purse, the specificity of the creative is the color of the purse, the brand of the purse, and/or other specific facts about the purse.

Subject tag: Metadata used to identify, index, and/or describe the specificity of a creative.

User: End-recipient of creative; e.g., web-user, application-user, or generally the party a merchant or ad campaign is targeting.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### DETAILED DESCRIPTION

The present invention generally relates to digital media and computer-implemented advertising systems and methods. More specifically, the present invention relates to systems and methods for monetizing a search interface.

In a typical search interface, a user provides a search engine (or query processor) with a search query (or search string). The search engine then uses keywords, titles, and/or indexing to search the Internet for relevant documents. Links (e.g., hyperlinks or thumbnails) are then returned to the user in order to provide the user with access to the relevant documents. At times, a user's search query may indicate a user's intent or interest in purchasing a particular product. As such, a search interfaces provides an opportunity to advertise various products or services. The methods and systems presented below provide a means for monetizing a search interface by using a user's search query to identify the user's purchase intent and provide one or more digital advertisements (i.e., creatives) corresponding to the purchase intent.

For example, in one embodiment, there is provided a computer-implemented advertising method. The method includes: (a) receiving a search query from a user; (b) identifying a plurality of documents responsive to the search query; (c) identifying a creative relevant to the search query; and (d) providing the user with an interface to view the plurality of documents and the creative. The method may further include the steps of: (1) identifying whether the search query includes words indicative of a purchase intent; (2) analyzing the search query to identify one or more nouns in the search query, wherein the noun is considered a product tag, and selecting the creative based on the product tag; (3) analyzing the search query to identify a subject tag and/or a product tag called for in the search query; (4) selecting the creative based on the product tag called for in the search query, wherein the content of the creative matches the product tag; (5) selecting the creative based on the subject tag called for in the search query, wherein the specificity of the creative corresponds with the subject tag; and/or any combination thereof.

The method may further include the step of cataloging a database of creatives to index the creatives with product tags and/or subject tags. The cataloging step may be performed before or after step (a). The cataloging step may be performed using software, human analysis, or crowdsourcing. More specifically, the method may further include the steps of: (1) maintaining a database of creatives, and indexing the creatives with product tags; (2) maintaining the database of creatives, and indexing the creatives with specificity tags; and/or (3) maintaining the database of creatives on an ad server.

In one embodiment, the method further includes the step of displaying links on a search interface. In one embodiment, for example, the search interface is provided with two proximate frames; the first frame includes the plurality of links to the responsive documents and the second frame includes the creative. In another embodiment, the interface includes images responsive to the search query and creatives relevant to the responsive images.

In yet another embodiment, the interface displays a plurality of thumbnails which serve as links to web images responsive to the search query. The interface may also display a plurality of thumbnails which serve as links to creatives and/or merchant websites relevant to the search query. As such, the methods and systems presented herein are particularly useful for monetizing an image search interface. Displaying thumbnails of creatives proximate to thumbnails of responsive search results may entice the user to click-through to a merchant website, and thus influence the user's purchase intent.

The following detailed description of the figures refers to the accompanying drawings that illustrate exemplary embodiments. Other embodiments are possible. Modifications may be made to the embodiments described herein without departing from the spirit and scope of the present invention. Therefore, the following detailed description is not meant to be limiting.

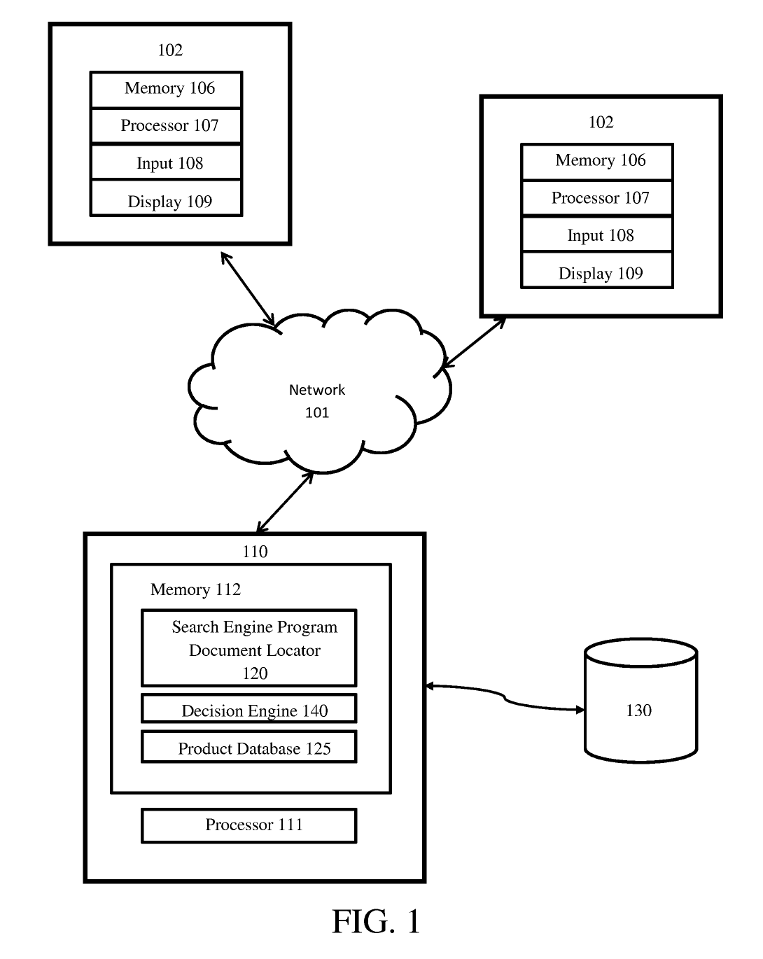

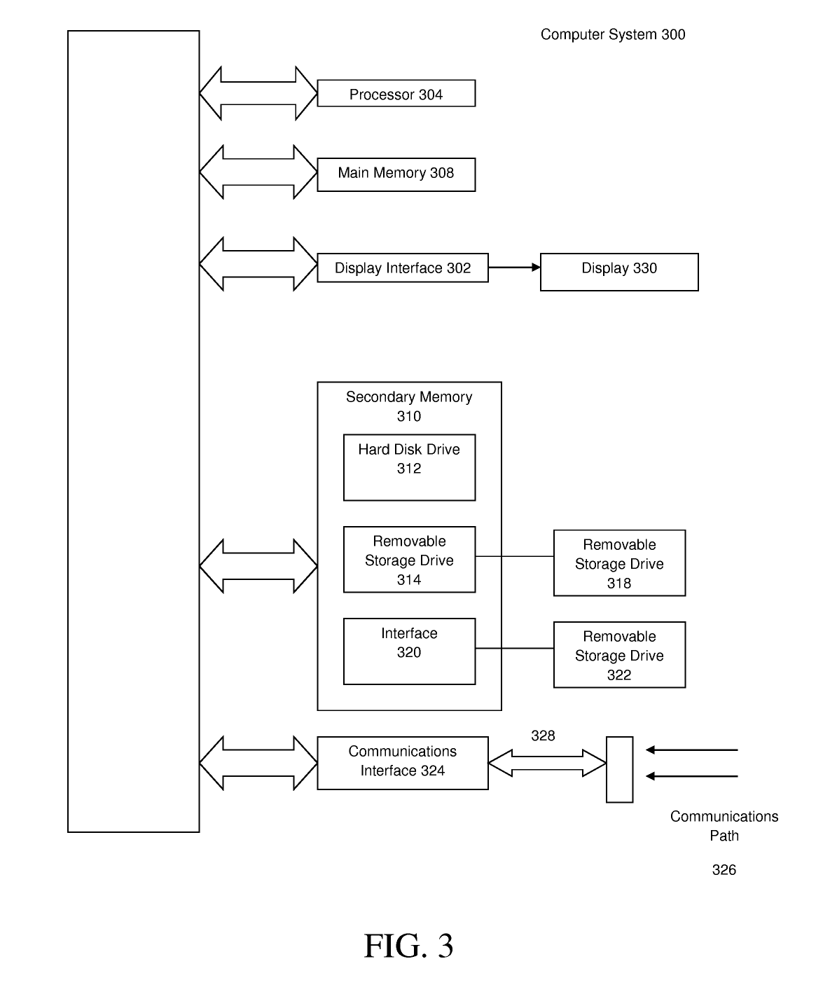

FIG. 1 is a high-level diagram illustrating a system for practicing the methods presented herein. The system includes multiple client devices 102, a server 110, and a network 101. Users of client devices 102 generally communicate and transfer information with each other and/or server 110 over network 101. For example, in one embodiment, communication between the various parties and components of the present invention is accomplished over a network consisting of electronic devices connected either physically or wirelessly, wherein digital information is transmitted from one device to another. Such devices (e.g., client devices 102 and/or server 110) may include, but are not limited to, a desktop computer, a laptop computer, a handheld device or PDA, a cellular telephone, a set top box, an Internet appliance, an Internet TV system, a mobile device or tablet, or the like. Exemplary networks include a Local Area Network, a Wide Area Network, an organizational intranet, the Internet, or the like. The functionality of an exemplary computer and network are further explained in conjunction with FIG. 3, below.

Client devices 102 each include a computer-readable medium 106, such as random access memory, coupled to a processor 107. Processor 107 executes program instructions stored in memory 106. Client devices 102 may also include a number of additional external or internal devices, such as input device 108 (e.g., a mouse, a keyboard, a touch-screen, etc.), and/or display 109. In general, client device 102 may be any type of computing platform connectable to network 101. Typically, the user accesses the network via a search interface (or digital content platform) on their client device 102. Search interfaces and digital content platforms may include, for example, web browsers, websites, software applications, mobile device applications, TV widgets, or equivalents thereof.

Similar to client devices 102, server 110 includes a processor 111 coupled to a computer-readable memory 112. Server 110 may additionally include a secondary internal or external storage element, such as product database 125 and/or external product database 130. Client processors 107 and server processor 111 can be any of a number of well known computer processors. Further, although server 110 is depicted as a single computer system, server 110 may be implemented as a network of computer processors.

Memory 112 contains a search engine program 120. In one embodiment, a user can input a search query, such as an image search query, on a search interface (or digital content platform) on their client device 102. Typically, a user asks server 110 to locate webpages or web images relating to a particular topic. The webpages or web images may be stored on server 110, client devices 102, or other servers/devices connected to network 101. The search query is sent to the server 110 via network 101.

Search engine program 120 then locates relevant information, such as web documents, in response to the search query. For example, in one embodiment, search engine program 120 includes a document locator component to find documents whose contents (e.g., images) are responsive to a user's search query. Responsive information is then returned to the user via network 101 to be displayed on the user's client device 102. In one embodiment, search engine program 120 may return a list of links (e.g., hyperlinks, thumbnails, etc.) pointing to documents identified as responsive or corresponding to the search query. Search engine program 120 may locate responsive documents by comparing the terms in the user's search query to the documents in other client devices 102, database 125, database 130, and/or equivalents thereof.

In one embodiment, database 125 and/or database 130 includes a plurality of cataloged creatives. Creatives may be downloaded from devices and systems connected to network 101, and/or provided directly from merchants or agencies with the intent to advertise to users of client devices 102.

Memory 112 also contains a decision engine program 140. In one embodiment, decision engine program 140 is used to identify a creative relevant to the search query. For example, decision engine program 140 may identify whether the search query includes words indicative of a purchase intent. Such purchase intent can then be used to identify and provide a relevant creative that may direct the user to a merchant's website. In one embodiment, decision engine program 140 analyzes the search query to identify one or more nouns in the search query. Each identified noun is then considered a product tag. The decision engine program 140 can then search database 125 or database 130 for creatives indexed with a matching product tag (matches need not be exact matches). Creatives (in the form of images, links, or other documents) with matching product tags can then be returned to the user for display on client device 102.

Additional descriptive words in the search query may be used to add specificity to the creative selection. For example, if a user submits an image search query for a “black purse,” search engine program 120 identifies a plurality of documents (e.g., webpages, web images, etc.) that are responsive to the search “black purse.” Decision engine program 140 identifies the term “purse” as a product tag indicative of a purchase intent. Decision engine program then searches product database 125, 130 for creatives matching product tag “purse.” The term “black” may be used as a subject tag to add specificity to the creative selection. After decision engine program 140 identifies one or more creatives relevant to the search “black purse” (e.g., a creative advertising a black purse), server 110 can then return to the user an interface to view the plurality of documents responsive to the search “black purse,” as well as one or more creatives advertising black purses.

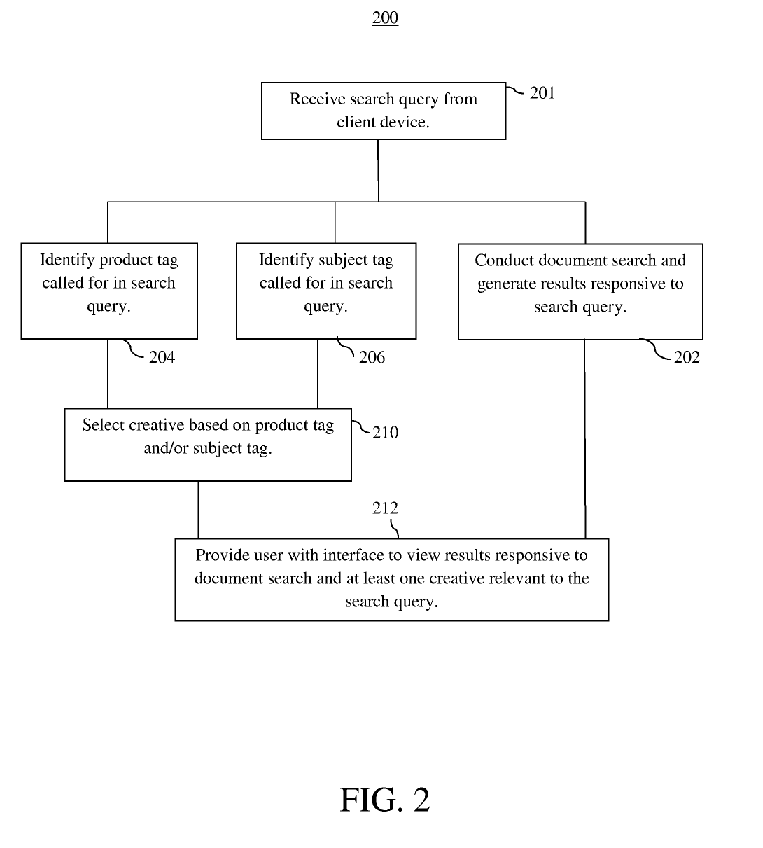

FIG. 2 is a flow-chart illustrating one embodiment presented herein. FIG. 2 illustrates a computer-implemented advertising method 200. First, a search query is received from a client device (step 201). Next, a search engine program is used to conduct a document search and generate results responsive to the search query (step 202). In parallel or series, a decision engine program is used to parse the search query and identify a product tag (step 204) and/or a subject tag (step 206) called for in the search query. The product tag and/or subject tag are then mapped against a database of creatives in order to select one or more relevant creatives (step 210). Finally, the user is provided with an interface to view the results responsive to the document search and at least one creative relevant to the search query (step 212). The relevancy of the creative selection may be set by a computer-implemented matching algorithm, a relevancy confidence level provided by a merchant or advertiser, by human analysis, or sub-systems equivalent thereto.

In another embodiment, there is provided a method comprising: (a) steps for receiving a search query from a user, which includes step 201 and equivalents thereof; (b) steps for identifying a plurality of documents responsive to the search query, which includes step 202 and equivalents thereof; (c) steps for identifying a creative relevant to the search query, which includes steps 204 and/or 206 and equivalents thereof; and (d) steps for providing the user with the plurality of documents and the creative, which includes step 212 and equivalents thereof. The method may further include: (1) steps for identifying whether the search query includes words indicative of a purchase intent; (2) steps for analyzing the search query to identify a subject tag and a product tag called for in the search query; (3) steps for selecting the creative based on the product tag called for in the search query, wherein the content of the creative matches the product tag; (4) steps for selecting the creative based on the subject tag called for in the search query, wherein the specificity of the creative corresponds with the subject tag; and/or (5) steps for displaying the plurality of documents and the creative on a search interface.

In yet another embodiment, there is provided a computer-based advertising system, comprising: means for receiving a search query; means for identifying a plurality of documents responsive to the search query; means for identifying a creative relevant to the search query; and means for providing the user with the plurality of documents and the creative. The means for receiving a search query may include a search interface, digital content platform, network communication protocols and systems, or systems equivalent thereto. The means for identifying a plurality of documents responsive to the search query may include search engine programs and protocols, and equivalents thereto. The means for identifying a creative relevant to the search query may include decision engine programs and protocols, search engine programs and protocols, and equivalents thereto. The means for providing the user with the plurality of documents and the creative may include output platforms on a computer-based system, network communication protocols and systems, search interfaces or platforms, a browser-executable program, links such as hyperlinks or thumbnails, or equivalents thereto. The computer-based advertising system may further include: means for identifying whether the search query includes words indicative of a purchase intent; means for analyzing the search query to identify a subject tag and a product tag called for in the search query; means for selecting the creative based on the product tag called for in the search query, wherein the content of the creative matches the product tag; means for selecting creative based on the subject tag called for in the search query, wherein the specificity of the creative corresponds with the subject tag; and/or means for displaying the plurality of documents and the creative on a search interface.

In still another embodiment, there is provided a computer-readable storage medium, having instructions executable by at least one processing device that, when executed, cause the processing device to: receive a search query from a user; identify a plurality of documents responsive to the search query; identify creatives relevant to the search query; and provide the user with the plurality of documents and creatives. The computer-readable storage medium may further comprise instructions executable by at least one processing device that, when executed, cause the processing device to: identify whether the search query includes words indicative of a purchase intent; analyze the search query to identify a subject tag and a product tag called for in the search query; select the creative based on the product tag called for in the search query, wherein the content of the creative matches the product tag; select the creative based on the subject tag called for in the search query, wherein the specificity of the creative corresponds with the subject tag; and/or display the plurality of documents and the creatives on a search interface.

The presented methods, or any part(s) or function(s) thereof, may be implemented using hardware, software, or a combination thereof, and may be implemented in one or more computer systems or other processing systems. For example, the presented methods may be implemented with the use of one or more dedicated ad servers. Where the presented methods refer to manipulations that are commonly associated with mental operations, such as, for example, receiving or selecting, no such capability of a human operator is necessary. In other words, any and all of the operations described herein may be machine operations. Useful machines for performing the operation of the methods include general purpose digital computers, hand-held mobile device or smartphones, or similar devices.

In one embodiment, the invention is directed toward one or more computer systems capable of carrying out the functionality described herein. An example of a computer system 300 is shown in FIG. 3. Computer system 300 includes one or more processors, such as processor 304. The processor 304 is connected to a communication infrastructure 306 (e.g., a communications bus, cross-over bar, or network). Computer system 300 can include a display interface 302 that forwards graphics, text, and other data from the communication infrastructure 306 (or from a frame buffer not shown) for display on a local or remote display unit 330.

Computer system 300 also includes a main memory 308, such as random access memory (RAM), and may also include a secondary memory 310. The secondary memory 310 may include, for example, a hard disk drive 312 and/or a removable storage drive 314, representing a floppy disk drive, a magnetic tape drive, an optical disk drive, flash memory device, etc. The removable storage drive 314 reads from and/or writes to a removable storage unit 318 in a well known manner. Removable storage unit 318 represents a floppy disk, magnetic tape, optical disk, flash memory device, etc., which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 314, removable storage units 318, 322, data transmitted via communications interface 324, and/or a hard disk installed in hard disk drive 312. These computer program products provide software to computer system 300. Embodiments of the present invention are directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the presented methods. Accordingly, such computer programs represent controllers of the computer system 300. Where appropriate, the processor 304, associated components, and equivalent systems and sub-systems thus serve as “means for” performing selected operations and functions.

In an embodiment where the invention is implemented using software, the software may be stored in a computer program product and loaded into computer system 300 using removable storage drive 314, interface 320, hard drive 312, or communications interface 324. The control logic (software), when executed by the processor 304, causes the processor 304 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A computer-implemented advertising method, comprising:
configuring a server to
(a) receive, over a network, a search query from an end-user's device;
(b) identify, with a search engine program document locator, one or more documents responsive to the search query;
(c) identify, with a decision engine, a cataloged creative relevant to the search query, wherein the cataloged creative is maintained in a product database; and
(d) provide the end-user's device with the one or more documents responsive to the search query and the cataloged creative relevant to the search query.

2. The method of claim 1, further comprising:
configuring the server to identify whether the search query includes words indicative of a purchase intent.

3. The method of claim 1, further comprising:
configuring the server to
analyze the search query to identify a noun in the search query, wherein the noun is considered a product tag, and
select the creative based on the product tag.

4. The method of claim 1, further comprising:
configuring the server to analyze the search query to identify a subject tag and a product tag called for in the search query.

5. The method of claim 4, further comprising:
configuring the server to select the creative based on the product tag called for in the search query, wherein the content of the creative matches the product tag.

6. The method of claim 5, further comprising:
configuring the server to index the creatives by product tags.

7. The method of claim 4, further comprising:
configuring the server to select the creative based on the subject tag called for in the search query, wherein the specificity of the creative corresponds with the subject tag.

8. The method of claim 7, further comprising:
configuring the server to index the creatives with specificity tags.

9. The method of claim 1, further comprising:
providing the end-user's device with an interface to display the documents and the creative.

10. The method of claim 9, wherein the search interface is provided with two proximate frames, and wherein the first frame includes links to the documents and the second frame includes a link to the creative.

11. The method of claim 1, further comprising:
configuring the server to provide the end-user's device with a plurality of creatives responsive to the search query.

12. A computer-readable storage medium for providing computer-implemented advertising method, comprising:
instructions executable by at least one processing device that, when executed, cause the processing device to
receive a search query from an end-user's device;
identify one or more documents responsive to the search query;
identify one or more creatives relevant to the search query; and
provide the end-user's device with the one or more documents and the one or more creatives in a search interface that displays the one or more creatives proximate to the one or more documents.

13. The computer-readable storage medium of claim 12, further comprising:
instructions executable by at least one processing device that, when executed, cause the processing device to identify whether the search query includes words indicative of a purchase intent.

14. The computer-readable storage medium of claim 12, further comprising:
instructions executable by at least one processing device that, when executed, cause the processing device to analyze the search query to identify a subject tag and a product tag called for in the search query.

15. The computer-readable storage medium of claim 14, further comprising:
instructions executable by at least one processing device that, when executed, cause the processing device to select the creative based on the product tag called for in the search query, wherein the content of the creative matches the product tag.

16. The computer-readable storage medium of claim 14, further comprising:
instructions executable by at least one processing device that, when executed, cause the processing device to select the creative based on the subject tag called for in the search query, wherein the specificity of the creative corresponds with the subject tag.
